(19) United States
(12) Patent Application Publication
(10) Pub. No.: US 2026/0061816 A1
(43) Pub. Date: Mar. 5, 2026

(54) AUTOMATIC BATTERY DISCONNECT SYSTEM FOR ELECTRIC VEHICLES USING TEMPERATURE DETECTION AND METHOD USING THE SAME

(71) Applicants: Un Chae Kim, Springfield, VA (US); Chae Jun Kim, Springfield, VA (US)

(72) Inventors: Un Chae Kim, Springfield, VA (US); Chae Jun Kim, Springfield, VA (US)

(21) Appl. No.: 18/830,539

(22) Filed: Sep. 10, 2024

(30) Foreign Application Priority Data
Aug. 28, 2024 (KR) 10-2024-0115568

(51) Int. Cl. B60K 1/04; B60L 3/00; B60L 3/04; H01M 10/48; H01M 50/249; H01M 50/262

(52) U.S. Cl. CPC B60K 1/04; B60L 3/0046; B60L 3/04; H01M 10/486; H01M 50/249; H01M 50/262; B60K 2001/0438; B60K 2001/0472; B60K 2001/0488; B60K 2001/0494; B60L 2250/16; B60L 2260/22

(57) ABSTRACT

An electric vehicle battery automatic disconnection system using temperature detection including a battery part configured to provide power to an electric vehicle, a sensor part configured to measure a temperature of the battery part and detect smoke, a connector part configured to charge the battery part, a casing part having an inner space for housing the battery part, and an electronic coupling part configured to couple the casing part to a lower part of the electric vehicle, in which the electronic coupling part is further configured to disconnect the casing part from the lower part of the electric vehicle when the temperature detected by the sensor part exceeds a predetermined threshold or when smoke is detected.

### CROSS-REFERENCE TO RELATED APPLICATION

This application claims priority from and the benefit of Korean Patent Application No. 10-2024-0115568, filed on Aug. 28, 2024, which is hereby incorporated by reference for all purposes as if fully set forth herein.

### BACKGROUND

### Field

Embodiments of the invention relate generally to an automatic battery disconnect system for electric vehicles, and more particularly, to an automatic battery disconnect system for electric vehicles that employs temperature detection to automatically sever the connection to a battery mounted on the electric vehicle to minimize damage when the temperature of the battery becomes excessively high or if a fire breaks out.

### Discussion of the Background

In the automotive sector, there is a pressing demand for energy sources other than fossil fuels. As such, significant advancements have been made in developing electric vehicles (EVs), which utilize electricity as a power source. EVs are being extensively researched and developed as a viable alternative, aiming to reduce reliance on traditional fuel sources and decrease environmental impact.

Electric vehicle batteries (EVBs) are rechargeable batteries that power the electric motors in battery electric vehicles (BEVs) or hybrid electric vehicles (HEVs). EVBs are typically lithium-ion batteries, specifically engineered to meet required energy capacities.

EVs are equipped with a drive motor to operate the vehicle and a high-voltage battery to store and supply power to the drive motor.

High-voltage battery systems in EVs, however, pose significant challenges in fire emergencies. For example, access to these batteries is difficult due to their placement in EVs, and they are typically enclosed or only have cooling ducts and holes, making traditional firefighting methods like fire extinguishers, water, or sand ineffective.

In general, fires in electric-powered vehicles result in total loss, leading to significant human and material damage. The difficulties in accessing and extinguishing the source of the fire often forces responders to let it burn out.

Moreover, fires in EVBs of EVs that are parked in underground parking lots pose additional challenges. For example, the inability to move the vehicle complicates firefighting efforts, significantly increasing the risk of extensive property and human damage. Therefore, there exists a pressing need for technology that can minimize damage in the event of a fire in an EVBs.

The above information disclosed in this Background section is only for understanding of the background of the inventive concepts, and, therefore, it may contain information that does not constitute prior art.

### SUMMARY

An electric vehicle battery automatic disconnection system using temperature detection according to embodiments of the invention is capable of automatically disconnecting a battery mounted on an electric vehicle to minimize damage when the temperature of the electric vehicle battery becomes excessively high or if a fire breaks out.

Additional features of the inventive concepts will be set forth in the description which follows, and in part will be apparent from the description, or may be learned by practice of the inventive concepts.

An electric vehicle battery automatic disconnection system using temperature detection according to an embodiment includes a battery part configured to provide power to an electric vehicle, a sensor part configured to measure a temperature of the battery part and detect smoke, a connector part configured to charge the battery part, a casing part having an inner space for housing the battery part, and an electronic coupling part configured to couple the casing part to a lower part of the electric vehicle, in which the electronic coupling part is further configured to disconnect the casing part from the lower part of the electric vehicle when the temperature detected by the sensor part exceeds a predetermined threshold or when smoke is detected.

The electronic coupling part may further include a coupling module coupling the casing part to the lower portion of the electric vehicle, and a control module configured to switch a locking-state of the coupling module.

When the electric vehicle is parked, the control module may be configured to unlock the coupling module to separate the casing part from the electric vehicle, when the temperature detected by the sensor part exceeds a predetermined threshold or when smoke is detected.

The control module may be configured to transmit signal to a display of the electric vehicle and send a notification text to an owner of the electric vehicle, when the temperature detected by the sensor part exceeds a predetermined threshold or when smoke is detected.

The control module may be configured to disconnect the casing part from the lower part of the electric vehicle after n seconds from transmitting the signal to the display.

The control module may be configured to allow the driver to manually control the locking-state of the coupling module, when the temperature detected by the sensor part exceeds a predetermined threshold or when smoke is detected.

The electric vehicle battery automatic disconnection system may further include a movable part coupled to a lower portion of the casing part, in which the movable part may be configured to transport the casing part out from the electric vehicle.

The movable part may include a main body unit coupled to a lower portion of the casing part, and a plurality of wheel units coupled to the lower portion of the main body unit.

The movable part may further include a movement control unit configured to control the wheel units to move the main body unit.

The moving part may further include a handle unit coupled to a side of the main body unit, and the handle unit may have a grip for manually moving the main body unit.

The electric vehicle battery automatic disconnection system may further include a slope portion coupled to the electric vehicle and arranged at a lower portion of the movable part, in which the slope portion may be configured to form an inclined plane with respect to the electric vehicle.

The slope portion may include a slope body coupled to a lower portion of the electric vehicle and covering the lower portion of the movable part, and a plurality of hinge modules arranged along a periphery of the slope body and coupled to the lower portion of the electric vehicle.

At least one hinge module may be formed on each side of the slope body.

The hinge modules arranged on at least three sides of the slope body may be disconnected from the electric vehicle when the temperature detected by the sensor part exceeds a predetermined threshold or when smoke is detected.

The movable part may be configured to slide outwardly away from the electric vehicle through the inclined plane.

The hinge module arranged on at least one side of the slope body may remain connected to the electric vehicle when the temperature detected by the sensor part exceeds a predetermined threshold or when smoke is detected.

When the temperature detected by the sensor part exceeds a predetermined threshold or when smoke is detected, a first group of the hinge modules may be disconnected from the electric vehicle and a second group of hinge modules remain coupled to the electric vehicle.

A number of the hinge modules in the first group may be greater than that of the second group.

The first group of the hinge modules may be determined based on current inclination of the electric vehicle.

A method of automatically disconnecting a battery part from an electric vehicle may utilize the electric vehicle battery automatic disconnection system described above. It is to be understood that both the foregoing general description and the following detailed description are illustrative and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a schematic view of an electric vehicle equipped with an electric vehicle battery automatic disconnection system using temperature detection according to an embodiment of the invention.

FIG. 2 is a schematic view of an electric vehicle battery automatic disconnection system using temperature detection according to an embodiment of the invention.

FIG. 3 is a schematic view of an electric vehicle battery automatic disconnect system using temperature detection according to another embodiment of the invention.

FIG. 4 is a schematic view of an electric vehicle battery automatic disconnection system using temperature detection according to an embodiment of the invention.

FIGS. 5 and 6 are schematic diagrams showing the operation of a hinge module of the electric vehicle battery automatic disconnection system using temperature detection according to an embodiment of the invention.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

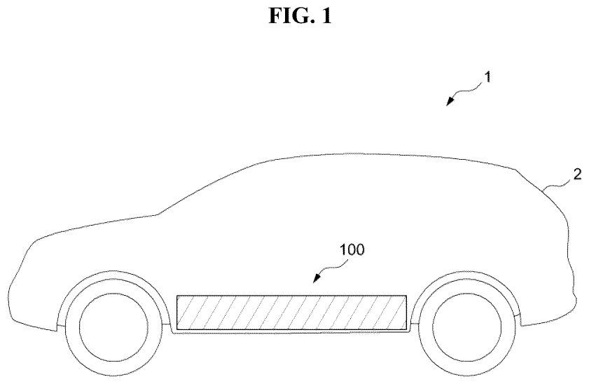

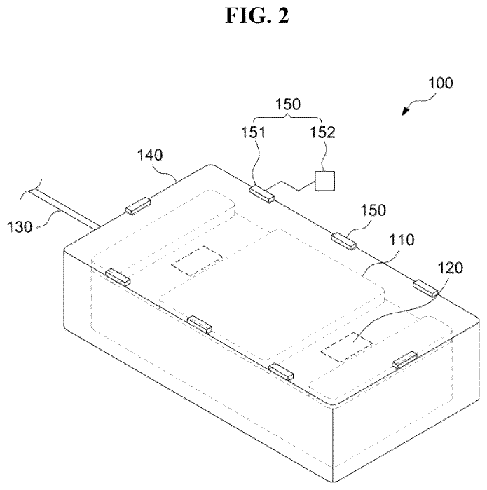

FIG. 1 is a schematic view of an electric vehicle equipped with an electric vehicle battery automatic disconnection system using temperature detection according to an embodiment of the invention. FIG. 2 is a schematic view of an electric vehicle battery automatic disconnection system using temperature detection according to an embodiment of the invention.

Referring to FIGS. 1 and 2, an automobile 1 employing an electric vehicle battery automatic disconnection system 100 using temperature sensing according to an embodiment may be an electric vehicle 2. The electric vehicle battery automatic disconnection system 100 using temperature sensing may include a battery part 110, a sensor part 120, a connector part 130, a casing part 140, and an electronic coupling part 150.

The battery part 110 may be configured as a module of a plurality of battery cells to provide power to an electric vehicle 2. The battery cells of the battery part 110 may have various capacities, sizes, and shapes commonly used in electric vehicles.

The sensor part 120 may be connected to the battery part 110, and measure the temperature of the battery part 110 and detect smoke. According to an embodiment, the sensor part 120 may include a temperature sensor and a smoke sensor. In some embodiments, each of the temperature sensor and the smoke sensor may be formed in plural, and may be positioned at various locations around the battery part 110.

The temperature sensor may detect, for example, overheating or a swift change in temperature of the battery part 110 within a short period of time beyond a predetermined value and/or range set by the electric vehicle manufacturer under standard driving or charging conditions.

In addition, the smoke sensor may detect smoke arising from the overheating and leakage of the battery part 110, as well as from electronics, wiring, connectors, and other components connected to the battery part 110. In some embodiments, other types of sensors, such as ionization sensors or photoelectric sensors, may be employed to detect such smoke.

The connector part 130 is connected with the battery part 110, and functions as a connector for charging the battery part 110 and as a power source for driving a motor of the electric vehicle 2. The connector part 130 may be detachably coupled to the battery part 110. In some embodiments, the connector part 130 may be formed as cables.

The casing part 140 may accommodate the battery part 110 therein, and may be positioned on the lower inner side of the electric vehicle 2 for stable weight distribution. The casing part 140 may include a high-strength, lightweight composite material to provide resistance to thermal and mechanical stresses, without being limited thereto.

The electronic coupling part 150 may couple (or engage) the casing part 140 to the lower inner side of the electric vehicle 2. In addition, the electronic coupling part 150 may disconnect (or disengage) the casing part 140 from the lower inner side of the electric vehicle 2 when the electric vehicle 2 is parked, and when the temperature of the battery part 110 measured by the sensor part 120 exceeds a predetermined threshold or if smoke is detected.

The electronic coupling part 150 according to an embodiment may include a coupling module 151 and a control module 152. The coupling module 151 may couple the casing part 140 to the lower part of the electric vehicle 2 in normal conditions, and the control module 152 may cause the coupling module 151 to disengage the casing part 140 from the lower part of the electric vehicle 2 in certain conditions. The electronic coupling part 150 may employ various locking mechanisms known in the art to securely couple the casing part 140 to the lower part of the electric vehicle 2.

More particularly, the coupling module 151 may be formed in plural and arranged along the periphery of casing part 140. Each of the coupling modules 151 may be in a locking-state during which the casing part 140 is coupled to the electric vehicle 2, and in an unlocking-state during which the casing part 140 is released from the electric vehicle 2. The locking-state and the unlocking-state of the coupling modules 151 may be switched via electronic control signal transmitted from the control moule 152. The shape and the arrangement of the coupling modules 151 are not limited to a particular shape or arrangement thereof.

The control module 152 may transmit electronic control signal to the coupling module 151 to switch between the locking-state and the unlocking-state of the coupling modules 151. In particular, the control module 152 may transmit electronic control signal to the coupling modules 151 such that the coupling modules 151 may release the casing part 140 from the electric vehicle 2, when the electric vehicle 2 is parked and when the temperature detected by the sensor part 120 exceeds a predetermined threshold or if smoke is detected, thereby disconnecting the casing part 140 from the electric vehicle 2.

Further, the control module 152 may transmit signals to a display panel or dashboard of the electric vehicle 2 to indicate fire warning and/or temperature of the battery part 110 when detected temperature of the battery part 110 by the sensor part 120 exceeds a predetermined threshold or when smoke is detected. In some embodiments, the control module 152 may also send a notification text to the owner of the electric vehicle 2.

The control module 152 may also be manually controlled by the driver, while the electric vehicle 2 is driven or parked, to change the locking status of the coupling modules 151 when the temperature detected by the sensor part 120 exceeds a predetermined threshold or when smoke is detected.

In particular, when the control module 152 detects that the battery part 110 is on fire while the electric vehicle 2 is in motion, the control module 152 can prompt the display panel of the electric vehicle 2 to offer the driver the choice of disengaging the battery part 110 from the electric vehicle 2. In this manner, the driver may select the safest moment to disengage the battery part 110 from the electric vehicle 2, considering its surrounding conditions. For example, disconnecting the battery part 110 while on a highway could potentially cause other accidents to nearby vehicles. As such, the driver may choose to manually disengage the battery part 110 from the electric vehicle 2 after moving the electric vehicle 2 to a safer location, such as a highway shoulder.

Alternatively, if the driver is unable to select the safest moment to disengage the battery part 110 when the battery part 110 overheats or catches fire while driving, the control module 152 may be configured to automatically disconnect the casing part 140 from the electric vehicle 2 after a predetermined time from giving a notice to the driver. For example, the automatic disconnection of the casing part 140 may be carried out after the control module 152 informs the driver that the coupling module 151 will disconnect the casing part 140, in a preset time frame of n seconds (n being a natural number). In such case, the driver can use the remainder of n seconds to move the electric vehicle 2 to a safer location before the battery part 110 is disconnected. In this manner, the disconnection may occur before the driver loses control of the electric vehicle 2 due to overheating or fire.

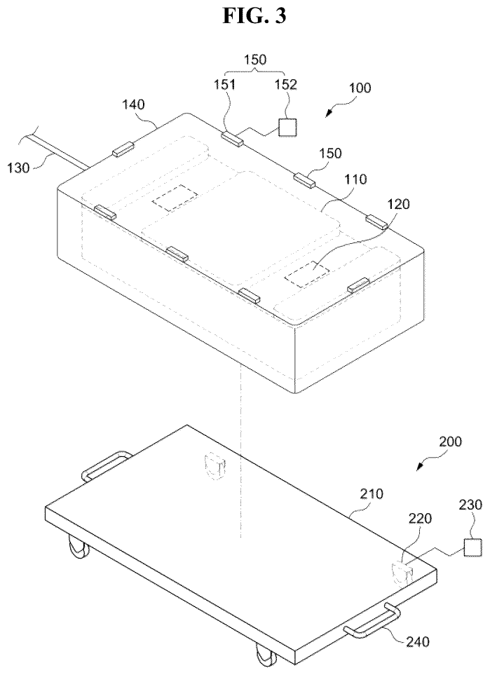

FIG. 3 is a schematic view of an electric vehicle battery automatic disconnect system using temperature detection according to another embodiment of the invention.

Referring to FIG. 3, the electric vehicle battery automatic disconnection system using temperature sensing according to an embodiment may further include a movable part 200. Since the electric vehicle battery automatic disconnection system according to the illustrated embodiment is substantially similar to the electric vehicle battery automatic disconnection system 100 described above, except for the movable part 200, repeated descriptions of substantially the same elements and features thereof will be omitted to avoid redundancy.

The movable part 200 may be provided on a lower part of the casing part 140. The movable part 200 may be movable to transport the casing part 140 that has been disconnected from the electric vehicle 2.

In particular, the movable part 200 may include a main body unit 210, a wheel unit 220, a movement control unit 230, and a steering wheel unit 240.

The main body unit 210 may be coupled to the lower portion of the casing part 140. The main body unit 210 may have a shape that generally conforms to the shape of the lower portion of the casing part 140, such as the shape of a plate. While figures exemplarily illustrate the main body unit 210 as having a substantially rectangular shape, however, the inventive concepts are not limited to a particular shape of the main body unit 210. In some embodiments, the main body unit 210 may have any shape so long as the battery part 110 can be stably mounted thereon. In other embodiments, the main body unit 210 may be omitted, and the wheel unit 220 may be coupled directly to the lower part of the casing part 140.

The wheel unit 220 may be formed in plural on the main body unit 210 or on the lower portion of the casing part 140. The wheel unit 220 may be retractably formed on the inner side of the main body unit 210, without being limited thereto.

The movement control unit 230 may control the wheel unit 220 to move the main body unit 210. In particular, the movement control unit 230 may motorize the retracting movement of the wheel unit 220 to control the rolling motion and direction of movement of the wheel unit 220. In this manner, the movement control unit 230 may control the wheel unit 220 to thereby transport the battery part 110 outwardly away from the lower part of the electric vehicle 2.

Under normal conditions, the movement control unit 230 may control the wheel unit 220 to be retracted into the inner side of the main body unit 210. However, when the electronic coupling part 150 detaches the casing part 140 from the electric vehicle 2, the movement control unit 230 may direct the wheel unit 220 to rotate to protrude from the main body unit 210 to facilitate ground contact and rolling movement. In this manner, the movement control unit 230 may minimize any protrusion of the wheel unit 220 from the lower part of the electric vehicle 2 during normal conditions.

The handle unit 240 is provided on a side of the main body unit 210 and functions as a handle for manually moving the main body unit 210. The handle unit 240 may be formed to have a shape that can be easily gripped by a person, allowing for the manual movement of the movable part 200.

In some embodiments, the handle unit 240 may be configured as a hook to facilitate the hanging of a flame-retardant string, hook, or similar hook-compatible items.

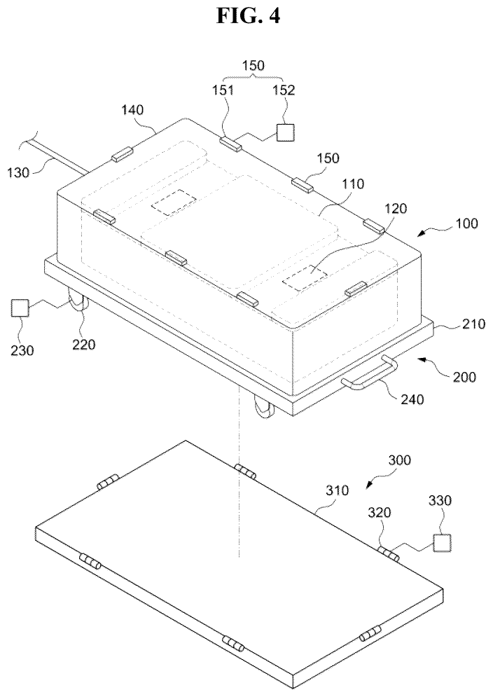

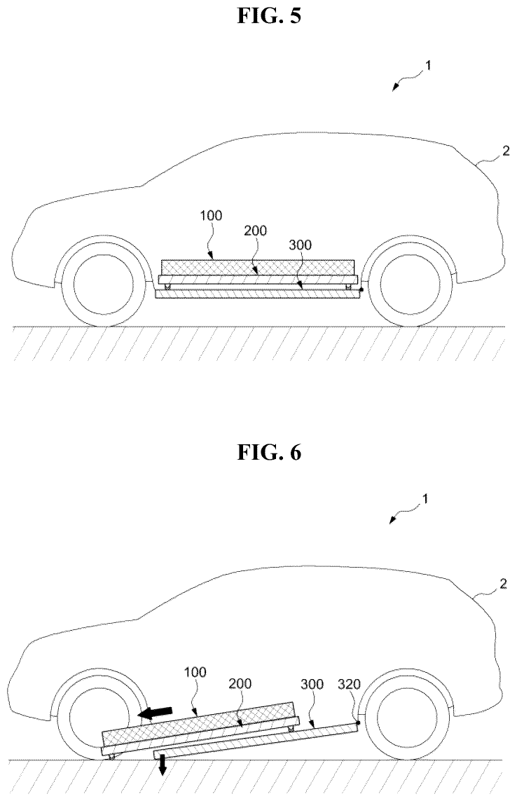

FIG. 4 is a schematic view of an electric vehicle battery automatic disconnection system using temperature detection according to an embodiment. FIGS. 5 and 6 are schematic diagrams showing the operation of a hinge module of the electric vehicle battery automatic disconnection system using temperature detection according to an embodiment.

Referring to FIGS. 4 to 6, the electric vehicle battery automatic disconnection system using temperature sensing according to an embodiment may further include a slope part 300. Since the electric vehicle battery automatic disconnection system according to the illustrated embodiment is substantially similar to the electric vehicle battery automatic disconnection system 100 described above, except for the slope part 300, repeated descriptions of substantially the same elements and features thereof will be omitted to avoid redundancy.

The slope part 300 may be coupled to the electric vehicle 2. However, the inventive concepts are not limited thereto, and in some embodiments, the slope part 300 may be formed at a lower portion of the movable part 200.

The slope part 300 may include a slope body 310, a hinge module 320, and a hinge control module 330.

The slope body 310 may be coupled to the lower part of the electric vehicle 2 and cover the lower part of the movable part 200. The slope body 310 may have a shape that generally conforms to the shape of the lower part of the movable part 200, such as the shape of a plate, without being limited thereto.

The hinge module 320 may be formed in plural, and arranged along a periphery of the slope body 310 and coupled to the lower part of the electric vehicle 2.

More particularly, at least one hinge module 320 may be provided on each side of the slope body 310. The hinge modules 320 may be rotated in one direction such that the slope body 310 presses against the underside of the electric vehicle 2. The hinge modules 320 may also be rotated in the opposite direction such that the slope body 310 moves away from the underside of the electric vehicle 2.

Each of the hinge modules 320 may be detachably coupled to the electric vehicle 2. For example, the hinge module 320 may include three parts. The center part of the hinge module 320 may rotate and be coupled to the slope body 310, and the two side parts of the hinge module 320 may be coupled to the lower part of the electric vehicle 2. The two side parts of the hinge module 320 may be separated from the lower part of the electric vehicle 2 upon receiving separation signal. More particularly, a hinge control module 330 may release a predetermined number of the hinge modules 320 from the electric vehicle 2 while having at least one hinge module 320 retain its coupling status with the electric vehicle 2, thereby allowing the slope body 310 to tilt and form an inclined plane with respect to the electric vehicle 2. In this manner, the movable part 200 may move or slide out from the electric vehicle 2 along the inclined plane.

More specifically, the hinge control module 330 may disengage the hinge modules 320 on three of the four sides of the slope body 310 from the electric vehicle 2, for example, if it is determined that a fire has occurred in the battery part 110. In this case, the hinge control module 330 may secure the hinge module 320 on the remaining side of the slope body 310 maintains its coupling to the electric vehicle 2, such that the corresponding side of the slope body 310 remains engaged with the electric vehicle 2. In this case, the hinge module 320 that stays connected may be rotated in the other direction by its own weight, thereby forming an inclined plane.

The above-described operating mechanism of the slope part 300 according to an embodiment may reduce manufacturing costs, as the movable part 200 may be moved out from the electric vehicle 2 without having to motorize the wheel unit 220. However, the inventive concepts are not limited thereto, and in some embodiments, the wheel unit 220 in the movable part 200 may be motorized to facilitate the movement of the movable part 200.

In an embodiment, the hinge control module 330 may further include a tilt sensor. The tilt sensor may detect the current inclination of the electric vehicle 2 to assist the hinge control module 330 in determining which direction the slope part 300 should be inclined towards.

For example, when the electric vehicle 2 is parked on an uphill slope, the movable part 200 may not be moved outwardly if the inclined plane formed by the slope part 300 faces uphill. In such case, the movable part 200 may slide or roll outwardly from the electric vehicle 2 when the inclined plane formed by the slope part 300 faces downhill. Accordingly, the hinge control module 330 may determine the hinge modules 320 to be disconnected based on the tilt information provided by the tilt sensor, to thereby facilitate removal of the movable part 200 from the electric vehicle 2.

In some embodiments, the wheel unit 220 may further include gears, buckles, retractors, and the like to physically stop the movable part 200 upon reaching a predetermined speed, on the principle of a seat belt, so as to prevent other accidents which may otherwise occur if the wheel unit 220 continues to move downhill. In this manner, the wheel unit 220 that has been discharged from the lower part of the electric vehicle 2 may travel downhill and stop upon reaching a predetermined speed by locking a gear in the wheel unit 220.

The automobile 1 equipped with an electric vehicle battery automatic separation system using temperature detection according to embodiments can minimize human and material damage because, in the event of a fire in the battery part 110, the battery part 110 is automatically separated from the electric vehicle 2 and moved outwardly from the lower part of the electric vehicle 2.

Furthermore, since the battery part 110 is moved outwardly from the lower part of the electric vehicle 2 and placed on the ground, extinguishing the fire in the battery part 110 may be facilitated. In particular, when the battery part 110 is caught on fire at underground level, such as an underground park lot where it is difficult to move the vehicle, only the battery part 110 removed from the electric vehicle 2 may be brought out to the ground level and extinguished more safely without fear of suffocation from smoke.

In addition, when the battery part 110 catches fire in a moving vehicle, the battery part 110 can be manually and immediately disconnected, thereby safeguarding the occupants of the vehicle.

According to embodiments, a battery part may be separated from the electric vehicle and moved outward from the lower part of the electric vehicle when the temperature of the electric vehicle battery becomes abnormally high or if caught on fires, thereby minimizing human and material damage.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. An electric vehicle battery automatic disconnection system using temperature detection comprising:
a battery part configured to provide power to an electric vehicle;
a sensor part configured to measure a temperature of the battery part and detect smoke;
a connector part configured to charge the battery part;
a casing part having an inner space for housing the battery part; and
an electronic coupling part configured to couple the casing part to a lower part of the electric vehicle,
wherein the electronic coupling part is further configured to disconnect the casing part from the lower part of the electric vehicle when the temperature detected by the sensor part exceeds a predetermined threshold or when smoke is detected.

2. The electric vehicle battery automatic disconnection system of claim 1, wherein the electronic coupling part further includes:
a coupling module configured to couple the casing part to the lower portion of the electric vehicle; and
a control module configured to switch a locking-state of the coupling module.

3. The electric vehicle battery automatic disconnection system of claim 2, wherein, when the electric vehicle is parked, the control module is configured to unlock the coupling module to separate the casing part from the electric vehicle, when the temperature detected by the sensor part exceeds a predetermined threshold or when smoke is detected.

4. The electric vehicle battery automatic disconnection system of claim 2, wherein the control module is configured to transmit signal to a display of the electric vehicle and send a notification text to an owner of the electric vehicle, when the temperature detected by the sensor part exceeds a predetermined threshold or when smoke is detected.

5. The electric vehicle battery automatic disconnection system of claim 4, wherein the control module is configured to disconnect the casing part from the lower part of the electric vehicle after n seconds from transmitting signal to the display.

6. The electric vehicle battery automatic disconnection system of claim 2, wherein the control module is configured to allow the driver to manually control the locking-state of the coupling module, when the temperature detected by the sensor part exceeds a predetermined threshold or when smoke is detected.

7. The electric vehicle battery automatic disconnection system of claim 1, further comprising a movable part coupled to a lower portion of the casing part,
wherein the movable part is configured to transport the casing part out from the electric vehicle.

8. The electric vehicle battery automatic disconnection system of claim 7, wherein the movable part includes:
a main body unit coupled to a lower portion of the casing part; and
a plurality of wheel units coupled to the lower portion of the main body unit.

9. The electric vehicle battery automatic disconnection system of claim 8, wherein the movable part further includes a movement control unit configured to control a retracting movement of the wheel units.

10. The electric vehicle battery automatic disconnection system of claim 8, wherein the moving part further includes a handle unit coupled to a side of the main body unit, and
wherein the handle unit has a grip for manually moving the main body unit.

11. The electric vehicle battery automatic disconnection system of claim 7, further comprising a slope portion coupled to the electric vehicle and arranged at a lower portion of the movable part
wherein the slope portion is configured to form an inclined plane with respect to the electric vehicle when the temperature detected by the sensor part exceeds a predetermined threshold or when smoke is detected.

12. The electric vehicle battery automatic disconnection system of claim 11, wherein the slope portion includes:
a slope body coupled to a lower portion of the electric vehicle and covering the lower portion of the movable part; and
a plurality of hinge modules arranged along a periphery of the slope body and coupled to the lower portion of the electric vehicle.

13. The electric vehicle battery automatic disconnection system of claim 12, wherein at least one hinge module is formed on each side of the slope body.

14. The electric vehicle battery automatic disconnection system of claim 13, wherein the hinge modules arranged on at least three sides of the slope body are disconnected from the electric vehicle when the temperature detected by the sensor part exceeds a predetermined threshold or when smoke is detected.

15. The electric vehicle battery automatic disconnection system of claim 14, wherein the hinge module arranged on at least one side of the slope body remains connected to the electric vehicle when the temperature detected by the sensor part exceeds a predetermined threshold or when smoke is detected.

16. The electric vehicle battery automatic disconnection system of claim 12, wherein the movable part is configured to slide outwardly away from the electric vehicle through the inclined plane.

17. The electric vehicle battery automatic disconnection system of claim 12, wherein, when the temperature detected by the sensor part exceeds a predetermined threshold or when smoke is detected, a first group of the hinge modules are disconnected from the electric vehicle and a second group of hinge modules remains coupled to the electric vehicle.

18. The electric vehicle battery automatic disconnection system of claim 17, wherein a number of the hinge modules in the first group is greater than that of the second group.

19. The electric vehicle battery automatic disconnection system of claim 1, wherein the first group of the hinge modules are determined based on current inclination of the electric vehicle.

20. A method of automatically disconnecting a battery part from an electric vehicle using the electric vehicle battery automatic disconnection system of claim 1.
